(19) United States
(12) Patent Application Publication
(10) Pub. No.: US 2016/0015180 A1
(43) Pub. Date: Jan. 21, 2016

(54) Sports Field Bench Seating Assembly

(71) Applicant: Felix Ramirez, Valley Center, KS (US)

(72) Inventor: Felix Ramirez, Valley Center, KS (US)

(21) Appl. No.: 14/873,014

(22) Filed: Oct. 1, 2015

(51) Int. Cl. A47C 7/02; A47C 7/62; G09F 23/00; A47C 1/16

(52) U.S. Cl. CPC A47C 7/021; A47C 1/16; A47C 7/62; G09F 23/00

(57) ABSTRACT

A seating assembly for attachment to a plank configured sports field bench, the plank having a front end, a width, a thickness, an upper surface, and a lower surface, the seating assembly including a cushion having front and rear ends, having an upper surface, and having a lower surface adapted for downward placement upon the plank's upper surface; a first pocket fixedly attached to the cushion's front end, the first pocket being adapted for, upon the cushion's placement upon the plank's upper surface, suspending downwardly from the plank's front end; and a cord matrix and hook combination connected operatively to the cushion, the combination being adapted for, upon the downward placement of the cushion upon the plank's upper surface, resisting movements of the cushion and the first pocket with respect to the plank.

### FIELD OF THE INVENTION

This invention relates to sports field seating such as bench plank configured stadium bleachers and similarly configured dugout or player area seating. More particularly, this invention relates to apparatus and assemblies for attachment to such sports field benches which are adapted for enhanced seating functions.

### BACKGROUND OF THE INVENTION

Sports field player staging areas such as a baseball field dugout commonly includes a bench configured seat having a plank or beam extending along the length of the dugout, such dugouts commonly including protective chain link fencing surrounding the seating area. During competitive play, such player staging areas tend to become cluttered with players' baseball mitts, caps, gloves, baseballs, drink bottles, and other sports play related items. Disorganization of such items within a dugout may hinder or interfere with the player's access to needed equipment and may undesirably degrade the team's ability to compete.

The instant inventive sports field seating assembly solves or ameliorates such problems by specially configuring a conventional bench seat cushion to multiply function for articles storage and for display of indicia bearing signs and placards.

### BRIEF SUMMARY OF THE INVENTION

The instant inventive assembly is intended for attachment to and use in association with sports field benches of the type which present a horizontally extending plank or beam raised approximately 18 inches above a floor or ground surface. In typical embodiments, such seating plank is between 10-14 inches in width, and has a vertical thickness between 1 and 2 inches. Such seating planks are typically composed of aluminum, plastic, or wood.

A first structural component of the instant inventive seating assembly comprises a rectangular and laterally oblongated cushion having front and rear ends, and having a lateral length between 14 and 22 inches, such length matching the dimensions of a commonly spaced bench seating area or section. In a preferred embodiment, the cushion component has a flat undersurface for secure abutting contact with the typically flat upper surface of a plank configured bench. Also in the preferred embodiment, the cushion component is composed of vinyl covered or fabric covered elastomeric foam, the foam layer being approximately ½″-1½″ thick. In a suitable though less desirable configuration, the invention's cushion component may be relatively thin and may comprise a single layer of durable flexible sheet material such as plastic or woven fabric.

A further structural component of the instant inventive assembly comprises a first pocket which is fixedly attached to and which normally extends or suspends downwardly from the cushion's front end. In a preferred embodiment, the first pocket opens upwardly and has a lateral length or left to right dimension spanning the majority of the lateral dimension of the cushion. The first pocket component preferably comprises open mesh panels which make the contents of the pocket viewable by sports players, and which conveniently allow air drying of the contents of the pocket.

Further structural components of the instant inventive seating assembly comprise releasable attaching means which are connected operatively to the cushion element. In the preferred embodiment, the releasable attaching means are adapted for, upon a downward and abutting placement of the cushion against the upper surface of a seating plank, resisting movement or displacement of the cushion and first pocket away from or along the seating plank.

In a preferred embodiment, the releasable attachment means comprise front and rear flexible tabs or flaps which are respectively fixedly attached to the front and rear ends of the cushion. Such tabs are preferably sized for extensions around the lower front and lower rear edges of a typically sized seating plank, and for being secured thereunder by a matrix of durable and flexible cords. While the above described flexible tabs and cord matrix combination releasable attaching means are preferred, other fastening assemblies capable of releasably positioning the cushion upon a flat bench top are considered to fall within the scope of the invention. As examples, fixed or pivoting “L” hooks or brackets which extend downwardly from the cushion's undersurface are considered to fall within the scope of the invention. As further examples, velcro or snap fastening plank enveloping flaps which extend about and meet at the undersurface of a bench plank are considered to fall within the scope of the invention. Further suitable alternate attaching means comprise annular clamps or straps which may extend about and tighten against a bench configured plank. The releasable attaching means suitably may further alternatively comprise a high friction or rubberized applique presented at the cushion's undersurface for resisting horizontal sliding movement of the cushion and attached first pocket along the upper surface of a bench plank.

In a preferred embodiment of the instant inventive seating assembly, a transparent flexible sheet is fixedly attached to the cushion's upper surface in a manner forming a second pocket which serves as a placard or display card or sheet receiving pocket. As sheet configured card or placard which is sized for sliding insertion into such second pocket and which bears printed indicia such as a team logo or a player name may be advantageously received and displayed within such second pocket. The incorporation of such second pocket and indicia bearing sheet combination advantageously allows the inventive assembly to additionally function as an informational and/or promotional sign.

Accordingly, objects of the instant invention include the provision of a seating assembly which incorporates structures as described above, and which arranges those structures in relation to each other in manners described above, for performance of the functions described above.

Other and further objects, benefits, and advantages of the instant invention will become known to those skilled in the art upon review of the Detailed Description which follows, and upon review of the appended drawings.

### BRIEF DESCRIPTION OF THE DRAWINGS

FIG. 1 is a perspective view of a preferred embodiment of the instant inventive seating assembly for attachment to a sports field bench.

FIG. 2 redepicts the structure of FIG. 1, the view of FIG. 2 showing a indicia bearing sheet received within a transparent pocket structure.

FIG. 3 is an undersurface view of structures depicted in FIGS. 1 and 2.

FIG. 4 presents an alternate configuration of the structures depicted in FIGS. 1-3.

### DETAILED DESCRIPTION OF A PREFERRED EMBODIMENT

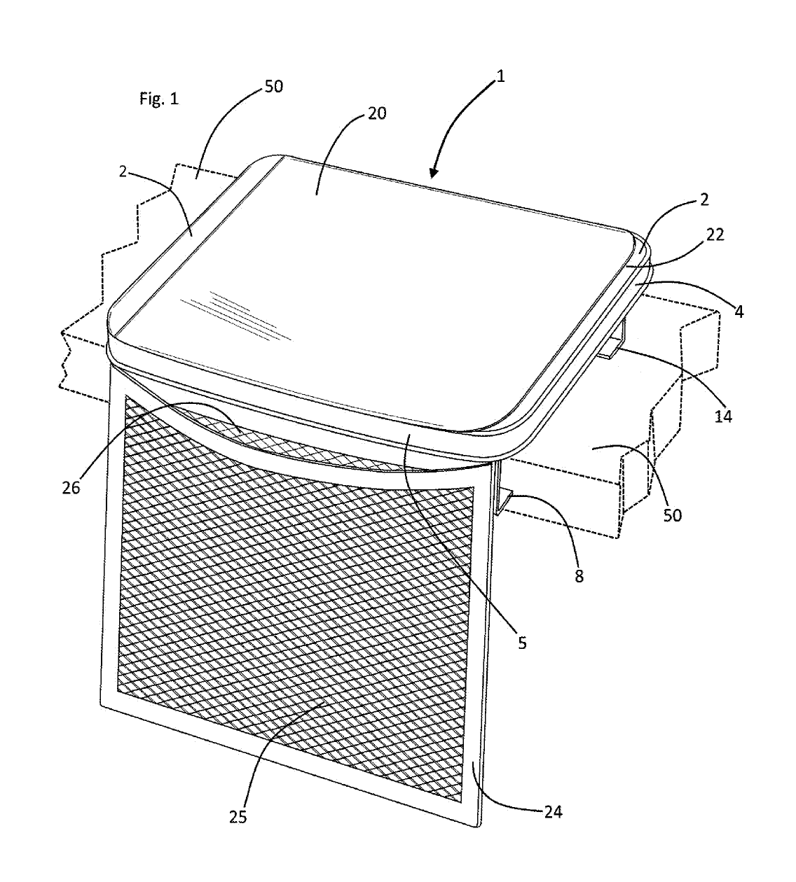

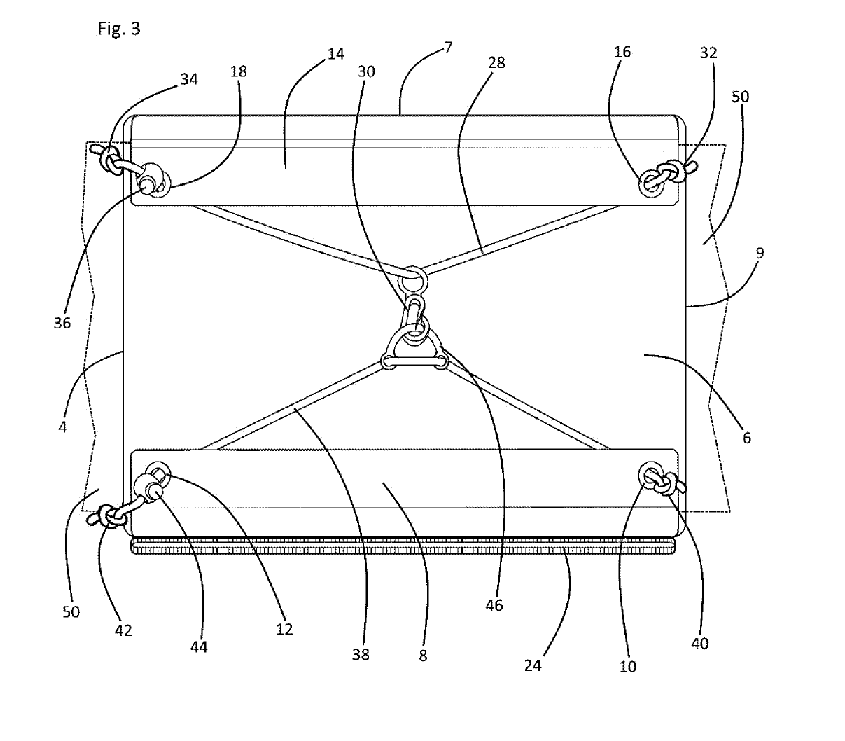

Referring now to the drawings, and in particular to Drawing FIGS. 1 and 3, a preferred embodiment of the instant inventive seating assembly for attachment to a sports field bench is referred to generally by Reference Arrow 1. The assembly 1 comprises a cushion component having an upper surface or wall 2, a lower surface or wall 6, a left side wall 4, a right side wall 9, a front wall 5, and a rear wall 7. In a preferred embodiment, the interior of the cushion component comprises sponge rubber or elastomeric foam, and the exterior walls of the cushion component are covered or upholstered with vinyl or a durable fabric. In the preferred embodiment, the left to right or lateral dimension of the cushion is between 18 and 22 inches, and the front to rear dimension of the cushion is commensurate with the width of a common sports bleacher or sports field bench plank 50, such dimension being 10 and 14 inches.

A first pocket 24 which preferably has an upper opening 26 is fixedly attached to and extends downwardly from the cushion's front wall 5. For purposes of viewing of pocket contents and air drying of the contents, the paired front and rear walls of the first pocket 24 are composed of an open mesh or netting material 25.

Referring simultaneously to FIGS. 1 and 3, in order to securely place the seating assembly 1 upon a bench plank 50, releasable attaching means are preferably securely mounted to the cushion component. In the preferred embodiment, the releasable attaching means comprise a matrix of durable flexible cords which attach to front and rear flexible tabs or flaps 8 and 14. In the preferred embodiment, such cord matrix attaching means incorporate eye grommets 10, 12, 16, and 18 which are impressed into the tabs 8 and 14, and receive the left and right ends of cord loops 28 and 38. Knots 32, 34, 40, and 42 secure such cord ends within such eyes, and at least a first cord lock 44 or 36 is mounted to the cords between a knot and an eye. In the preferred embodiment, as depicted, each of the cord loops 8 and 14 is tightenable and releasable via a cord lock.

The cord loops 28 and 38 may advantageously comprise elastic “bungie” or shock cord. Upon the depressions of spring biased buttons of the cord locks 36 and 34, knotted cord ends 34 and 42 may be pulled therethrough, effectively reducing the lengths of and tightening the cord loops 28 and 38. The releasable attaching means preferably further comprise a hook 30 and latch loop 48 which respectively receive the cord loops 28 and 38. Upon engaging hook 38 with latch loop 46 beneath a bench plank 50, and upon tightening of cord ends 34 and 42 through cord locks 36 and 44, the front and rear flexible tabs or flaps 8 and 14 may be securely drawn about the front and rear edges of the plank 50, effectively securing the assembly 1 to the plank 50. Convenient detaching steps include depression of the button of either one of the cord locks 36 or 34, followed by detachment of hook 30. Thereafter, the seating assembly 1 may be conveniently withdrawn from the plank 50 for use elsewhere or for storage.

The depicted cord matrix releasable attaching means is intended as being representative of other suitably substituted releasable attaching means such as snap fastener or velcro attached enveloping flaps (not depicted within views), rigid plank engaging “L” hooks or brackets (not depicted within views), annular draw-tight clamps or straps, and friction enhancing rubberized surfaces. Each of such suitably substituted releasable attaching means is considered to fall within the scope of the invention.

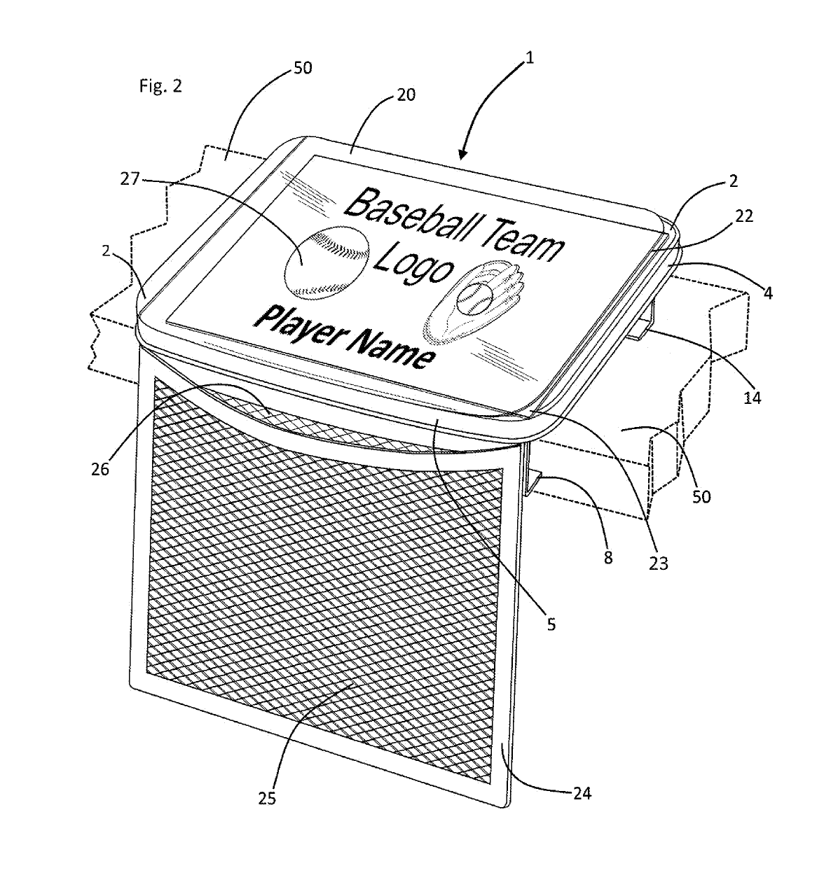

Referring to FIG. 2, the instant inventive seating assembly preferably further comprises a flexible plastic transparent sheet 20 which is fixedly attached to the upper surface of the cushion, preferably at the cushion's forward and rearward ends. Such transparent sheet 20 functions in combination with the upper surface 3 of the cushion to form a second pocket having at least a first card or sheet receiving opening 22. A card or sheet configured placard 23 bearing indicia 27 such as a team logo, mascot or emblem, or a player's name, may be advantageously slidably inserted into and received within such second pocket.

In use of the inventive seating assembly, referring simultaneously to FIGS. 1 and 2, the coach of, for example, a little league baseball team, may obtain multiple renditions of the seating assembly 1, the number of such renditions matching the number of players on his or her baseball team. Thereafter, printed sheets 23 bearing the printed names of each of the team's players (and optionally additionally bearing other indicia such as a team logo or name) may be inserted into the second pocket openings 22. Provided that a bench plank 50 is installed within the team's baseball field dugout, such coach may secure each of the assemblies 1 in a lateral series upon the plank 50, each assembly 1 being securely mounted in the manner depicted in FIG. 3. Thereafter, each baseball team member, upon entering the dugout, may utilize the seating assembly 1 bearing his or her name as an assigned seating place. Such player may advantageously utilize the pocket 24 secured at his or her seat for holding in an orderly and organized fashion personal equipment such a batting glove, a baseball mitt, or a water bottle.

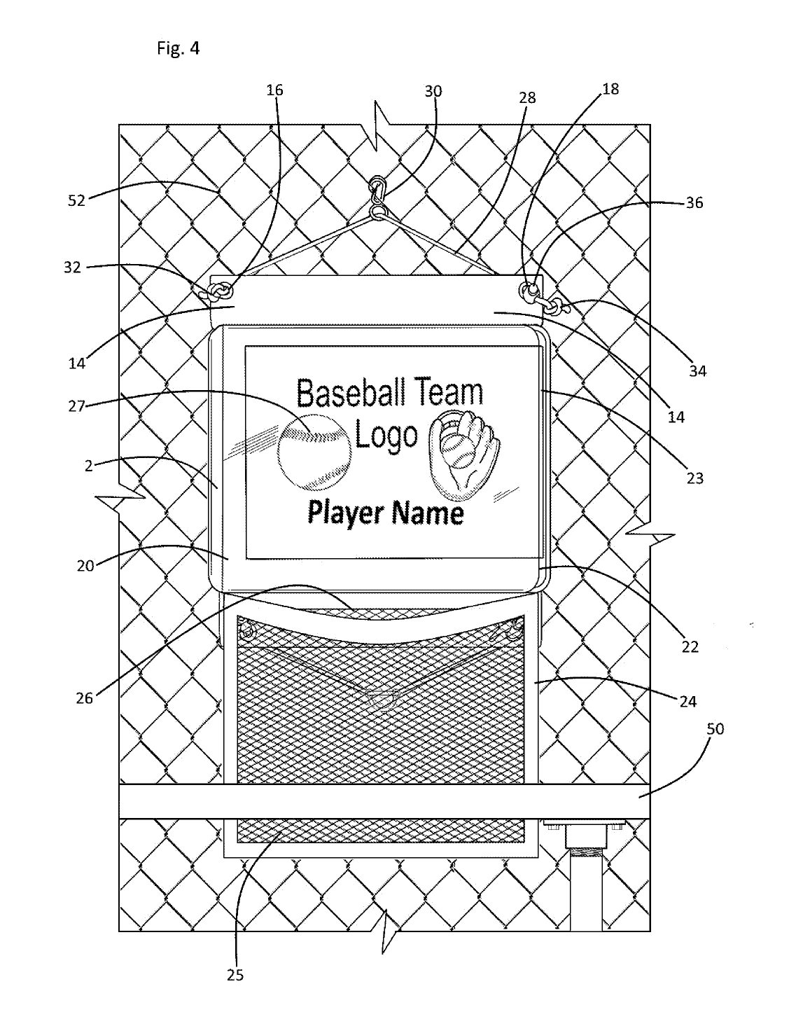

Referring to FIG. 4, as an alternative to the usage configuration depicted in FIGS. 2 and 2, the little league coach may utilize the attaching means' hook 30 to suspend the assembly 1 in a manner allowing the rear cord loop 28, the flexible tab 14, the cushion 2 transparent pocket 20 and indicia sheet 23 combination, and the first pocket 24 to suspend in vertical sequence downwardly from a hooking or hanging point. Such hanging point may suitably comprise a nail protruding from a wall surface, or where a dugout is surrounded by protective chain link fencing 52 (as depicted) such fencing may provide a convenient hanging point. The alternate configuration of FIG. 4 may be suitably utilized where the assembly's releasable attaching means are not suitably matched for attachment to seating surfaces available within the dugout.

In a further alternative mode of usage of the instant inventive seating assembly 1, sports event spectators who are seated upon plank configured bleachers may utilize the inventive assembly in a manner substantially identical to the player and dugout usage described above. Where a spectator utilizes the inventive assembly at a viewing stands location, the printed indicia 27 appearing upon the indicia display sheet 23 may advantageously alternatively portray the logo or mascot of a favored sports team.

While the principles of the invention have been made clear in the above illustrative embodiment, those skilled in the art may make modifications in the structure, arrangement, portions and components of the invention without departing from those principles. Accordingly, it is intended that the description and drawings be interpreted as illustrative and not in the limiting sense, and that the invention be given a scope at least commensurate with the appended claims.

The invention hereby claimed is:

1. A seating assembly for attachment to a sports field bench, the sports field bench comprising a plank having front and rear ends, a width, a thickness, and upper and lower surfaces, the seating assembly comprising:
(a) a cushion having front and rear ends, and having upper and lower surfaces;
(b) a first pocket fixedly attached to the cushion's front end, the first pocket being adapted for, upon placement of the cushion upon the plank's upper surface, suspending from the plank's front end; and
(c) releasable attaching means connected operatively to the cushion, said means being adapted for, upon the cushion placement, resisting movement of the cushion and the first pocket with respect to the plank.

2. The seating assembly of claim 1 further comprising a flexible transparent sheet fixedly attached to the cushion's upper surface, the flexible sheet forming in combination with the cushion's upper surface a second pocket.

3. The seating assembly of claim 2 further comprising an indicia bearing sheet received within the second pocket.

4. The seating assembly of claim 2 wherein the releasable attaching means comprise front and rear flexible tabs respectively fixedly attached to the cushion's front and rear ends.

5. The seating assembly of claim 4 wherein the releasable attaching means further comprise a matrix of cords fixedly attached to the front and rear flexible tabs.

6. The seating assembly of claim 5 wherein the matrix of cords comprises a pair of loops, and wherein the releasable attaching means further comprise a hook fastener adapted for interconnecting the pair of loops at the plank's lower surface.

7. The seating assembly of claim 6 wherein the matrix of cords exposes at least a first cord end, and wherein the releasable attaching means further comprise at least a first tab eye and cord lock combination, said at least first combination's tab eye and cord lock receiving the at least first cord end.

8. The seating assembly of claim 6 further comprising an indicia bearing sheet received within the second pocket, and wherein one of the cord matrix's loops is fixedly attached to the rear flexible tab, the hook fastener being fixedly attached to the one of the loops for, upon upward extensions of the hook fastener and the one of the loops from the cushion, suspending the cushion, the first pocket, the indicia bearing sheet, and the second pocket.

9. The seating assembly of claim 6 wherein the first pocket is composed of an open mesh material.
